(19) United States
(12) Patent Application Publication
(10) Pub. No.: US 2009/0107763 A1
(43) Pub. Date: Apr. 30, 2009

(54) Toddler stair block

(76) Inventor: James W. Poston, JR., Little Mountain, SC (US)

Correspondence Address: James W. Poston Jr., 284 Bear Creek Rd, Little Mountain, SC, 29075, US

(21) Appl. No.: 11/977,295

(22) Filed: Oct. 24, 2007

(51) Int. Cl. E04F 11/00; E06C 7/00

(52) U.S. Cl. 182/106

(57) ABSTRACT

A child safety barrier for stairs that is placed on the lower step of a stairway is block-like for filling the space overlying the lower step in depth and laterally, and has an upper surface having a downwardly curved slope from its highest point at the step rear riser to the forward edge of the step. The barrier prevents a young child from climbing the stairs by obstructing their access to the step and the sloped surface causes their knees and hands to slide off the barrier, as their upper bodies are not strong enough to pull themselves over the barrier. The barrier is preferably composed of a pressure molded polyurethane material, which provides a closed outer skin that is easily cleaned and an inner porous structure that is compressible to a flat shape by the weight of an older child or adult allowing easy navigation.

### REFERENCES CITED

### U.S. PATENT DOCUMENTS

U.S. Pat. No. 1,235,411 July 1917 Andrews
U.S. Pat. No. 2,270,909 January 1942 Spizer
U.S. Pat. No. 2,535,544 December 1950 McKinley . . . 182/106
U.S. Pat. No. 3,225,863 December 1965 Ludlow . . . 182/230
U.S. Pat. No. 3,303,906 February 1967 Bouwmeester . . . 182/106
U.S. Pat. No. 3,311,195 March 1967 Singer . . . 182/230
U.S. Pat. No. 3,372,772 March 1968 Singer . . . 182/230
U.S. Pat. No. 3,428,146 February 1969 Bair . . . 182/106
U.S. Pat. No. 3,439,775 April 1969 Henrie . . . 182/138
U.S. Pat. No. 3,743,281 July 1973 Gimbel . . . 272/56.5 R
U.S. Pat. No. 3,796,429 March 1974 Johnston . . . 272/56.5 R
U.S. Pat. No. 4,579,197 April 1986 Spurling . . . 182/106
U.S. Pat. No. 4,664,225 May 1987 Coutier . . . 182/106
U.S. Pat. No. 4,991,691 June 1990 Brawer . . . 182/106

### FEDERALLY SPONSORED RESEARCH OR DEVELOPMENT

Not Applicable

### BACKGROUND OF THE INVENTION

1. Field of the Invention

The invention relates to the field of stairway safety barriers for small children and especially to a resilient block for a stairway step intended to prevent toddlers from climbing by providing a sloped surface which prevents the child from placing their knee on the step but which is easily compressed by an adults weight when they step on the block allowing easy passage.

2. Prior Art

Known safety barriers for children are predominantly gates. The gates are held in place either by hinges or through the use of friction once the gate is expanded against lateral surfaces. Such gates have the advantage that they can be used in doorways or can be placed either at the top or the bottom of a stairway.

One disadvantage to the safety gate for use on stairways is that in many cases it can be difficult to install, as banisters may not provide adequate surface to obtain the required friction. The lateral surface also may not be adequate for the mounting of hinges. A hinge installation is also a more permanent installation and as a result necessitates unsightly holes, which remain after the gate is removed requiring additional repairs.

Another disadvantage of the safety gate is that this obstacle is not only an impediment for the child but the adult as well. The adult either must open or remove and replace the gate or step or hop over which can be very difficult and especially cumbersome. U.S. Pat. No. 4,991,691 (Brawer) discloses a stair barrier that provides a sloped plane that spans two steps but which is still very difficult for an adult to traverse. The patent does provide a hinge where the barrier can be folded as to define a one step ramp that adults can more easily step over. However this requires manipulation of the barrier and the barrier must be unfolded back into the two-step span to provide its intended benefit.

### SUMMARY OF THE INVENTION

The present invention provides a soft, child friendly stair barrier in the form of a block with a downwardly curved slope at its forward edge providing a sliding surface that prevents young children from climbing onto the block. The barrier however, easily compresses to a flat surface under the weight of an adult allowing them to use the stairs with out the need to negotiate a gate or step over an obstacle. The compression of the block allows an adult to continue everyday activities such as carrying objects up and down the stairs while providing a constant barrier to young children that may attempt to climb the stairs.

### BRIEF DESCRIPTION OF THE DRAWINGS

Shown in the drawings of the invention are the embodiments presently preferred. The invention is not limited to a precise size or shape and the drawings provided serve only to provide options for the configuration:

FIG. 1 is a perspective view of the stair barrier shown in position on a stairway.

FIG. 2 is a side elevation of the structure shown in FIG. 1.

FIG. 3 is a side elevation of the barrier under compression.

FIG. 4 is a cross section of the barrier.

FIG. 5 is a cross section of other means for providing a compressible barrier.

FIG. 6 shows a selection of barriers with different profiles in accordance with this invention.

### DETAILED DESCRIPTION OF THE PREFERRED EMBODIMENTS

The invention provides a stair barrier for preventing young children who are crawling or relatively new walkers from climbing stairs, the barrier being compact, lightweight and portable. The stair barrier prevents these young children from being able to place their knee on the step, which prevents them from climbing as they lack the upper body strength to pull them selves up and over the sloped surface.

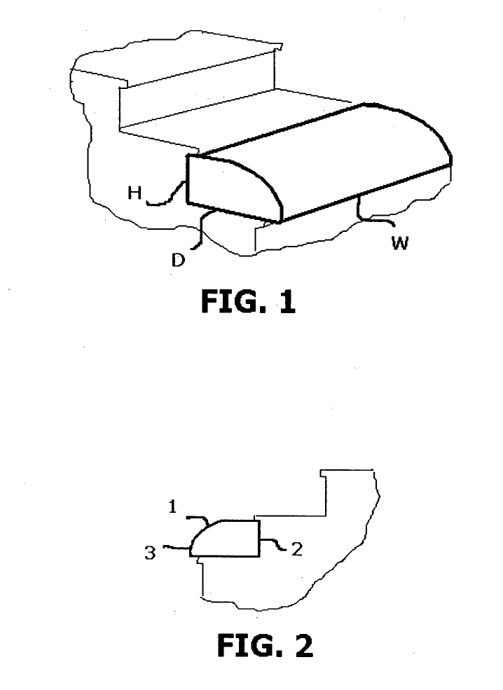

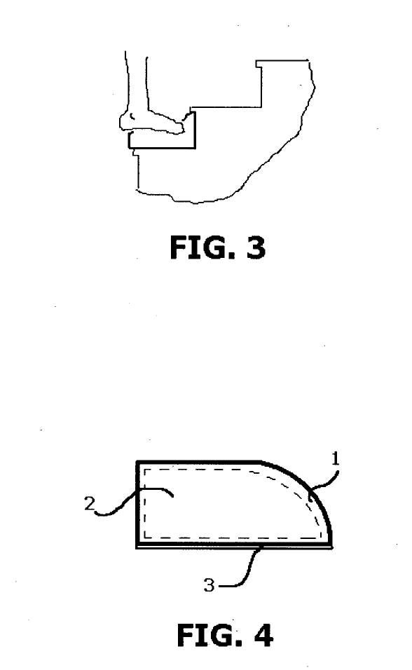

When installed as shown in FIG. 1, the stair barrier would fit snugly on the stairway taking up the full width of the stair and would be similar to the height of a full stair. The barrier as seen in FIG. 2, would have a curved slope I extending from the riser 2 to the step forward edge 3 causing a young child's hands or knees to slide off. The step barrier can have a variety of profiles as seen in FIG. 6. The slope also allows adults to easily raise their foot to a height sufficient to be placed on top of the barrier while not requiring extra effort to step or hop over the barrier. As described below, the barrier is resiliently compressible, and the barrier is compressed, as shown in FIG. 3, when the weight of an adult is applied making the height distance of the step relatively similar to a standard step allowing for easy navigation. The compressed block would immediately return to its original shape when the weight of the adult has been removed and would not compress under the small weight of a very young child.

As seen in FIG. 1, the stair barrier will normally be configured to a height H similar to that of the step riser and slightly longer than the width W of a full stair as it can be compressed to form fit columns, banisters or stairways that are more narrow than the width of the barrier there by providing a snug fit. The ability to compress in a lateral direction enables the barrier to accommodate a wide range of stair widths. The stair block would be deep enough to cover the entire depth D of a stair and may extend slightly beyond the forward edge 1 of the stair.

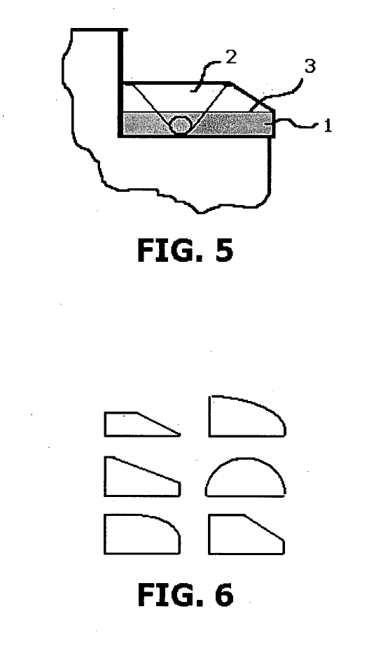

The stair barrier is preferably molded from polyurethane rounded contours avoiding any sharp corners that could hurt a child. An example would be polyol-isocyanate poured into epoxy resin moulds. As seen in FIG. 4 the preferred embodiment comprises, as it is removed from its mould, a closed outer skin 1 that is soft, smooth and easily cleaned with soap and water, and an inner region 2 of a porous nature that is compressible and provides an automatic immediate return to its molded shape. The compression could also be accomplished by use of rigid components. An example would be the use of at least one inner spring seen in FIG. 5. The top section 2 could collapse down into the bottom section 1 shown in grey. The horizontal line 3 represents the separation of the top and bottom sections so that one section can house the spring mechanism and allow for compression.

A skid resistant surface 3 would be on the bottom, as seen in FIG. 4, to prevent inadvertent movement and would grip very well to hardwood floor or carpet. An example is a slip resistant rubberized mat or paint.

What is claimed is:

1. A child safety barrier for stairs comprising a block-like polyurethane member for being placed on a stair step for blocking access to the step, the member being rounded, smooth and compressible with a closed outer skin which is durable and easily cleaned and a resilient inner porous region.

2. A child safety barrier as claimed in claim 1 with a slip resistant bottom.

3. A child safety barrier for placement on a lower step of a pair of successive steps of a stairway, said barrier comprising a block-like member including a surface curving, when the barrier is in place on the step, upwardly from said lower step to the successor step foreclosing off access to said lower step.

4. A child safety barrier according to claim 3 wherein said surface extends from the front edge of said lower step to the front edge of the successor step.

5. A child safety barrier according to claim 3, said surface being sufficiently rigid for presenting a sliding, non-climbable surface to a small child but being deformable to a flat, step-like surface under the weight of a larger child.

6. A child safety barrier according to claim 5 wherein said block is formed of polyurethane and has a generally right-angled cross-section, the hypotenuse of the right angle comprising said upwardly curved surface of said block.

7. A child safety barrier for placement on a lower step of a pair of successive steps of a stairway, said barrier comprising a block-like member having a shape for filling a space bounded by said lower step, a riser at the rear of said lower step extending between said steps, and a downwardly curved surface extending from a top edge of said riser to a front edge of said lower step, said block curved surface being sufficiently rigid for presenting a sliding surface to a small child preventing climbing over the block by the child, but being deformable to a flat stepping surface under the weight of a larger child.
